(19) United States
(12) Patent Application Publication
(10) Pub. No.: US 2009/0188519 A1
(43) Pub. Date: Jul. 30, 2009

(54) TOOTHBRUSH WITH DENTAL FLOSS HOLDER

(76) Inventors: Francie L. VanBuskirk, Estero, FL (US); M. Todd VanBuskirk, Estero, FL (US)

Correspondence Address: EDWARD M. LIVINGSTON, PA, 963 TRAIL TERRACE DRIVE, NAPLES, FL, 34103, US

(21) Appl. No.: 12/020,119

(22) Filed: Jan. 25, 2008

(51) Int. Cl. A45D 44/18; A46B 11/00; A61C 15/00; A46B 9/04

(52) U.S. Cl. 132/309; 132/311; 132/324; 132/328; 15/167.1

(57) ABSTRACT

A toothbrush with dental floss holder (1) having an elongated hollow handle (2) having an interior (22), an exterior (23), a first end (3), a second end (4), a plurality of bristles (5) located on the first end (3), a dental floss holder (8) located on the second end (4), an axle (15) internally located within the handle (2) for holding a spool (12) of dental floss (16) and an aperture (17) located on the handle (2). To use, a person threads the dental floss (16) through the aperture (17) so as to expose the dental floss (16) external to the handle (2). Then, the user wraps the dental floss (16) around the dental floss holder (8) and secures the dental floss (16) to the handle (2) so as to create a taut line of dental floss (16) for use between the teeth.

### BACKGROUND OF THE INVENTION

This invention relates to toothbrushes, more particularly, a toothbrush with dental floss holder that conveniently stores a predetermined amount of dental floss in a toothbrush from ready use availability.

Currently, most dental floss is sold in small containers having a dispensing means and a cutter. The dental floss is internally located within the container and is wound around a spool, exits the container via a dispensing means and is cut by a user via the cutter. Although the container prevents contamination of the dental floss located therein, oftentimes it is difficult to locate the dental floss container itself when desired. In addition, even if a person places the dental floss container in a specific location, such as a purse, tote bag, travel bag or vehicle glove compartment, because the containers are small, oftentimes they are still difficult to find. Thus, many people do not floss their teeth as much as they should to maintain good oral hygiene.

Although there are flossing devices that are located on the end of an elongated handle, thereby permitting a user to store the flossing device on a conventional toothbrush holder, these devices are unsanitary as such utilize a predetermined amount of dental floss on a cartridge that is exposed to the air. Moreover, the dental floss on each cartridge can be used only one time, thereby requiring the user to continuously purchase new dental floss cartridges, which can become quite costly.

Thus, a need exists for a toothbrush with dental floss holder that conveniently stores a predetermined amount of dental floss within a toothbrush.

The relevant prior art includes the following references:

| Patent No. | | |
|---|---|---|
| (U.S. unless | | Issue/Publication |
| stated otherwise) | Inventor | Date |
| Des. 420,805 | Bahl | Feb. 22, 2000 |
| 3,939,853 | Spanondis | Feb. 24, 1976 |
| 5,722,440 | Urso | Mar. 03, 1998 |
| 2,735,436 | Russo | Feb. 21, 1956 |
| 4,788,990 | Wisegerber | Dec. 06, 1988 |
| 6,076,535 | Yipp | Jun. 20, 2000 |
| 3,094,996 | Lewis | Jun. 25, 1963 |
| 2,962,033 | Lew | Nov. 29, 1960 |
| 7,174,904 | Ochs et al. | Feb. 13, 2007 |
| 7,171,971 | Ochs et al. | Feb. 06, 2007 |
| D497,222 | Ochs et al. | Oct. 12, 2004 |
| JP2004255184 | Ochs et al. | Sep. 16, 2004 |
| EP1449495 | Ochs et al. | Aug. 25, 2004 |

### SUMMARY OF THE INVENTION

The primary object of the present invention is to provide a toothbrush with dental floss holder that conveniently stores a predetermined amount of dental floss within a toothbrush.

Another object of the present invention is to provide a toothbrush with dental floss holder that is easy to use.

A further object of the present invention is to provide a toothbrush with dental floss holder that is sanitary.

An even further object of the present invention is to provide a toothbrush with dental floss holder that is portable.

Another object of the present invention is to provide a toothbrush with dental floss holder that may be stored in a conventional toothbrush holder.

The present invention fulfills the above and other objects by providing a toothbrush with dental floss holder having an elongated hollow handle having an interior and an exterior, said elongated handle having a first end and second end, a plurality of bristles located on said first end, a dental floss storage means located internal to said elongated handle, a predetermined amount of dental floss contained by said dental floss storage means, a dental floss dispensing means located on said elongated handle for dispensing a desired amount of said dental floss and a dental floss holder located on said second end for holding a desired amount of said dental floss.

The dental floss storage means is preferably an axle located within the interior of the hollow handle to permit a user to removably place a spool of dental floss thereon while the dental floss dispensing means is preferably at least one aperture located on the elongated handle. To use, a person first places the spool of dental floss on the axle and threads the exposed end of the dental floss through the aperture. Then, he or she holds the exposed end of the dental floss, pulls the exposed end and wraps a predetermined amount of dental floss around a button located on the handle. The user then extends the dental floss over prongs located on holder arms of the dental floss holder so as to create a taut line of dental floss between the prongs. Finally, he or she wraps the dental floss around the button once again and places the exposed end of the dental floss through a notch on the button to secure the dental floss in a locked and usable position.

The above and other objects, features and advantages of the present invention should become even more readily apparent to those skilled in the art upon areading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front plan view of a toothbrush with dental floss holder of the present invention;

FIG. 2 is a side plan view of the toothbrush with dental floss holder of the present invention;

FIG. 3 is an end view of the embodiment of FIG. 1;

FIG. 4 is a top view of a button of the toothbrush with dental floss holder of the present invention;

FIG. 5 is a front plan view of the toothbrush with dental floss holder of the present invention having removable handle sections;

FIG. 6 is a side view of a top section of the toothbrush with dental floss holder of the present invention;

FIG. 7 is a front view of the toothbrush with dental floss holder of the present invention having a hinged cover; and

FIG. 8 is a cross-sectional plan view along line 8-8 of the embodiment of FIG. 2.

### DESCRIPTION OF THE PREFERRED EMBODIMENTS

For purposes of describing the preferred embodiment, the terminology used in reference to the numbered components in the drawings is as follows:

| | |
|---|---|
| 1. | toothbrush with dental floss |
| | holder, generally |
| 2. | elongated handle |
| 3. | handle first end |
| 4. | handle second end |
| 5. | bristles |
| 6. | dental floss storage means |
| 7. | dental floss dispensing means |
| 8. | dental floss holder |
| 9. | prongs |
| 10. | first holder arm |
| 11. | second holder arm |
| 12. | spool |
| 13. | button |
| 14. | notch |
| 15. | axle |
| 16. | dental floss |
| 17. | aperture |
| 18. | first handle section |
| 19. | second handle section |
| 20. | hinge |
| 21. | cover |
| 22. | handle interior |
| 23. | handle exterior |
| 24. | axle mounting |
| 25. | exposed end |

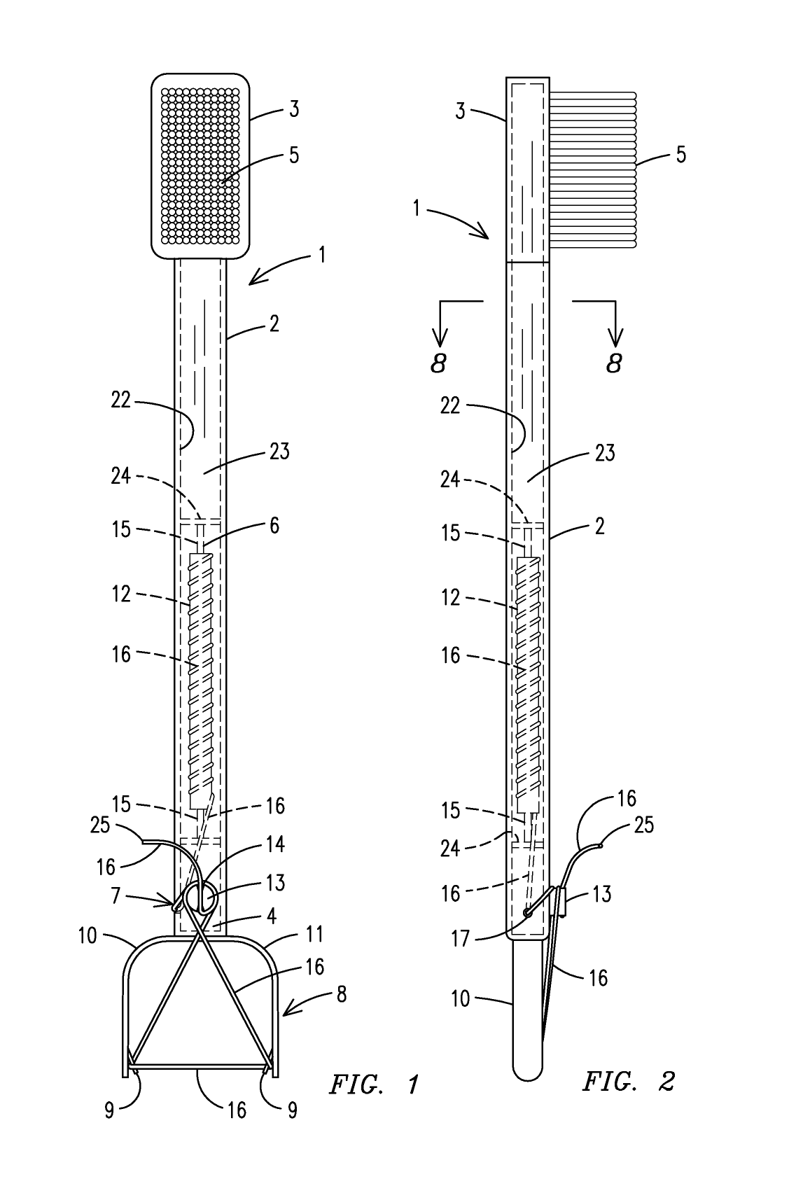

With reference to FIGS. 1 and 2, varying views of a toothbrush with dental floss holder of the present invention are shown. The toothbrush with dental floss holder, generally 1, includes an elongated handle 2 that is hollow having a first end 3, a second end 4, an exterior 23 and an interior 22. Located on the handle first end 3 is a plurality of bristles 5, such as those commonly found on the head of conventional toothbrushes. On the handle second end 4 is a dental floss holder 8 having a first holder arm 10 and a second holder arm 11. A button 13 having a notch 14 is preferably located on the handle exterior 23.

Internally located within the elongated handle 2 is a dental floss storage means 6 for storing a predetermined amount of dental floss 16 within the elongated handle 2. A dental floss dispensing means 7 is located on the elongated handle 2 to permit a user to thread the dental floss 16 located within the elongated handle 2 through the dental floss dispensing means 7 so as to have a predetermined amount of dental floss 16 external to the elongated handle 2.

To use the toothbrush with dental floss holder 1 of the present invention, a user first positions a predetermined amount of dental floss 16 for containment on/within the floss storage means 6. Preferably, the dental floss 16 is wound on a spool 12 and placed on an axle 15 located within the elongated handle 2. An exposed end 25 of the dental floss 16 is then threaded through the floss dispensing means 7, which is preferably an aperture 17, so a predetermined amount of dental floss 16 is now external to the toothbrush with dental floss holder 1. Then, the user holds the exposed end 25 of the dental floss 16, pulls the exposed end 25 so as to have a predetermined amount of dental floss 16 and wraps a portion of the dental floss 16 around the button 13 located on the elongated handle 2. Because the axle 15 is secured, preferably on both ends of the axle 15, to an axle mounting 24 located within the elongated handle 2, the spool 12 rotates on the axle 15 when the dental floss 16 is pulled by the user.

The dental floss 16 is then extended over prongs 9 located on the holder arms 10 and 11 of the dental floss holder 8 so as to create a taut line of dental floss 16 between the prongs 9. Finally, the user wraps the dental floss 16 around the button 13 once again and places the exposed end 25 of the dental floss 16 through a notch 15 on the button 13 to secure the dental floss 16 in a locked and usable position for insertion between the user's teeth.

Because the floss holder 8 is located on the second end 4 of the elongated handle 2 of the toothbrush with dental floss holder 1, a user may quickly and easily rotate the toothbrush with dental floss holder 1 from use as a toothbrush to use as a flosser.

Moreover, because the floss holder 8 extends vertically from elongated handle 2, a person is permitted better and easier access to flossing one's teeth when compared to flossing devices having floss holders perpendicular to the handle.

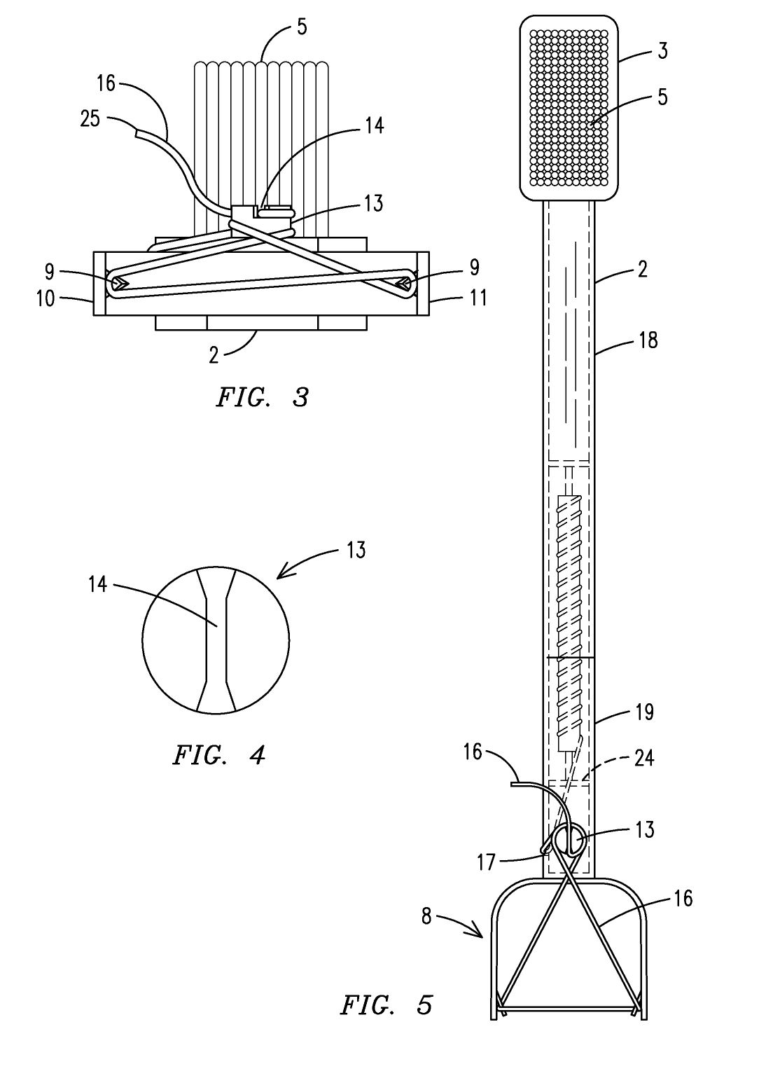

Next, FIG. 3 shows an end view of the embodiment of FIG. 1. The dental floss 16 is positioned over the flosser 8 and is held in place via prongs 9 located on each holder arm 10 and 11. The dental floss 16 is wrapped around the button 13 when the dental floss 16 is first pulled through the aperture 17 and once again after placing the dental floss 16 on the dental floss holder 8.

FIG. 4 shows a top view of a button 13 of the toothbrush with dental floss holder 1 of the present invention. The button 13 preferably includes at least one notch 14 for placement and securement of dental floss 16 therein.

Next, FIGS. 5 and 6 show varying views of the toothbrush with dental floss holder 1 of the present invention having removable handle sections 18 and 19. The elongated handle 2 has a first handle section 18 and a second handle section 19 that may be removed from one another to permit a user to access the floss storage means 6 internally located within the toothbrush with dental floss holder 1. In this manner, a user may refill the dental floss 16 by removing an empty spool 12 and replacing it with a full spool 12 of dental floss 16.

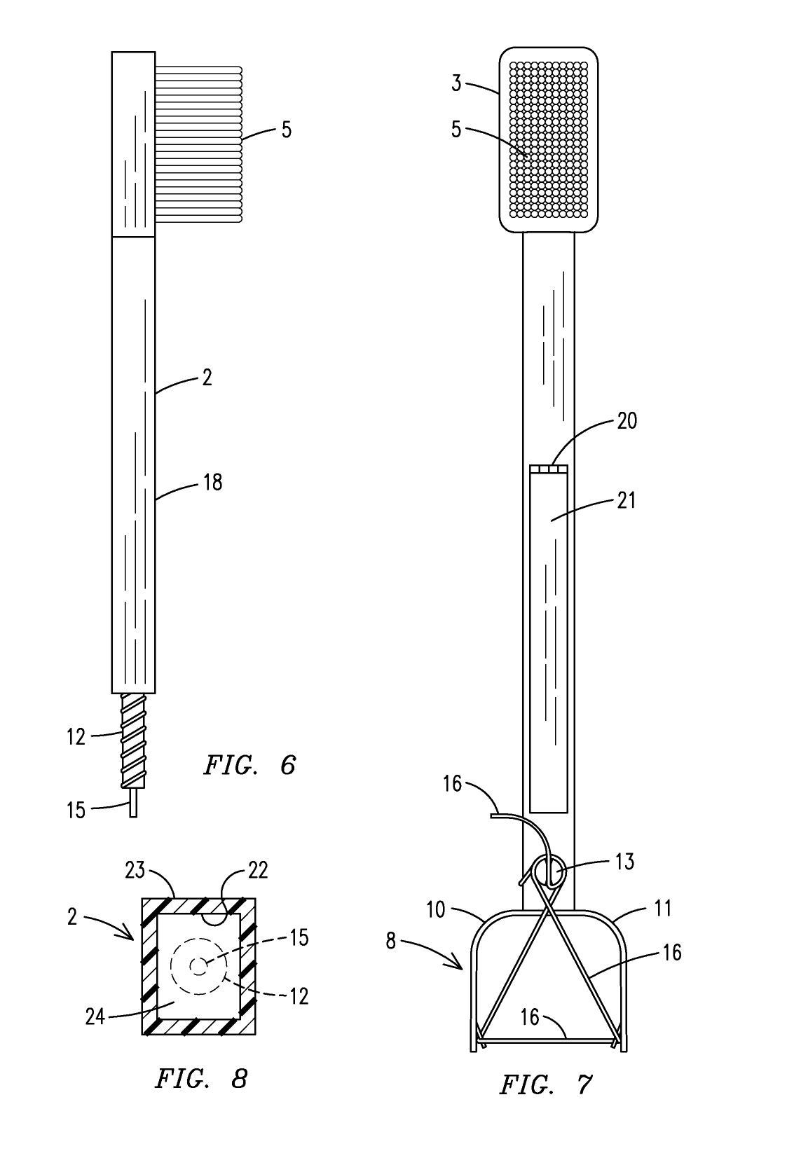

With reference to FIG. 7, a front view of the toothbrush with dental floss holder 1 of the present invention having a hinged cover 21 is shown. The cover 21 is secured to the elongated handle 2 by a hinge 20 to permit a user to access the floss storage means 6 internally located within the toothbrush with dental floss holder 1 for quick and easy replacement of dental floss 16.

Finally, FIG. 8 shows a cross-sectional plan view along line 8-8 of the embodiment of FIG. 2. The elongated handle 2 has an interior 22 and an exterior 23 wherein the spool 12 is mounted on an axle 15 within the elongated handle. Because the axle 15 is secured within the elongated handle 2 by at least one axle mounting 24, the spool 12 of dental floss 16 is permitted to unwind when a user pulls the exposed end 25 of the dental floss 16.

The use of the present invention permits a user to conveniently store a predetermined amount of dental floss within a toothbrush.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A toothbrush with dental floss holder comprising:
an elongated hollow handle having an interior and an exterior;
said elongated handle having a first end and second end;
a plurality of bristles located on said first end;
a dental floss storage means located internal to said elongated handle;
a predetermined amount of dental floss contained by said dental floss storage means;
a dental floss dispensing means located on said elongated handle for dispensing a desired amount of said dental floss; and
a dental floss holder located on said second end for holding a desired amount of said dental floss in a use position.

2. The toothbrush with dental floss holder of claim 1 wherein:
said dental floss storage means is preferably at least one axle located within said elongated handle.

3. The toothbrush with dental floss holder of claim 2 wherein:
said at least one axle is fixedly secured within said elongated handle.

4. The toothbrush holder of claim 1 wherein:
said dental floss dispensing means is at least one aperture located on said elongated handle.

5. The toothbrush holder claim 2 wherein:
said dental floss dispensing means is at least one aperture located on said elongated handle.

6. The toothbrush holder claim 3 wherein:
said dental floss dispensing means is at least one aperture located on said elongated handle.

7. The toothbrush with dental floss holder of claim 1 wherein:
said dental floss holder extends from said elongated handle.

8. The toothbrush with dental floss holder of claim 2 wherein:
said dental floss holder extends from said elongated handle.

9. The toothbrush with dental floss holder of claim 3 wherein:
said dental floss holder extends from said elongated handle.

10. The toothbrush with dental floss holder of claim 4 wherein:
said dental floss holder extends from said elongated handle.

11. The toothbrush with dental floss holder of claim 5 wherein:
said dental floss holder extends from said elongated handle.

12. The toothbrush with dental floss holder of claim 6 wherein:
said dental floss holder extends from said elongated handle.

13. The toothbrush with dental floss holder of claim 2 wherein:
said predetermined amount of dental floss is located on a spool; and
said spool is removably located on said at least one axle.

14. The toothbrush with dental floss holder of claim 3 further comprising:
said predetermined amount of dental floss is located on a spool; and
said spool is removably located on said at least one axle.

15. The toothbrush with dental floss holder of claim 1 further comprising:
at least one button located on the exterior of the handle for wrapping said desired amount of dental floss therearound to anchor the floss during use.

16. The toothbrush with dental floss holder of claim 15 wherein:
said at least one button has at least one notch located thereon.

17. The toothbrush holder of claim 1 wherein:
said elongated handle has a first section and a second section; and
said second section is removable from said first section.

18. The toothbrush with dental floss holder of claim 1 further comprising:
a hinged cover located on said elongated handle to permit access to said dental floss storage means.

19. A toothbrush with dental floss holder comprising:
an elongated hollow handle having an interior and an exterior;
said elongated handle having a first end and second end;
a plurality of bristles located on said first end;
at least one axle located within said elongated handle;
a spool of dental floss removably located on said at least one axle;
at least one aperture located on said elongated handle for dispensing a desired amount of said dental floss; and
a dental floss holder located on said second end for holding a desired amount of said dental floss wherein said dental floss holder extends from said elongated handle.

20. The toothbrush with dental floss holder of claim 19 further comprising:
at least one button located on handle exterior for wrapping said desired amount of dental floss therearound.

21. The toothbrush holder of claim 20 wherein:
said elongated handle has a first section and a second section; and
said second section is removable from said first section.

22. The toothbrush with dental floss holder of claim 21 further comprising:
a hinged cover located on said elongated handle to permit access to said dental floss storage means.
